(19) United States
(12) Patent Application Publication
(10) Pub. No.: US 2015/0377107 A1
(43) Pub. Date: Dec. 31, 2015

(54) FLUID CONTROL VALVE DEVICE

(71) Applicant: Hamanakodenso Co., Ltd., Kosai-city (JP)

(72) Inventors: YASUNARI FUJITA, Hamamatsu-city (JP); JUNICHIRO ITO, Hamamatsu-city (JP)

(21) Appl. No.: 14/747,034

(22) Filed: Jun. 23, 2015

(30) Foreign Application Priority Data
Jun. 25, 2014 (JP) 2014-130484

(51) Int. Cl. F01N 3/22; F01N 3/10; F16K 3/02

(52) U.S. Cl. CPC F01N 3/227; F16K 3/0218; F16K 3/0227; F16K 3/0254; F01N 3/101; F01N 3/225

(57) ABSTRACT

A fluid control valve device includes a seal part disposed to a valve seat of a housing. The seal part is elastically deformable and contacts a valve part when a fluid passage is closed. The seal part has a surface opposing the valve part, a first projection part projected from the surface toward an upper surface of the valve part, and a second projection part defined to surround the first projection part and projected from the surface toward the upper surface of the valve part. The second projection part is adjacent to the upper surface of the valve part than the first projection part is.

### CROSS REFERENCE TO RELATED APPLICATION

This application is based on Japanese Patent Application No. 2014-130484 filed on Jun. 25, 2014, the disclosure of which is incorporated herein by reference in its entirety.

### TECHNICAL FIELD

The present disclosure relates to a fluid control valve device that controls a flow of fluid flowing through a fluid passage.

### BACKGROUND

JP 2008-75827A (corresponding to U.S. 2008/0073605 A1) describes a fluid control valve arranged in a secondary air feed system that warms up a three-way catalyst at a time of starting a gasoline engine. Specifically, secondary air generated in a secondary air pipe is introduced to a three-way catalyst converter corresponding to an exhaust gas cleaning apparatus. The fluid control valve integrally has an electromagnetic valve which opens and closes a secondary air passage defined inside the housing, and a check valve that restricts fluid such as exhaust gas from flowing backwards to the electromagnetic valve and an electric air pump inside the system.

The electromagnetic valve includes a housing, a valve, a coil spring, and a seal rubber. The secondary air passage defined in the housing integrally has a valve seat. The valve reciprocates in the axial direction to approach or separate from the valve seat The coil spring biases the valve in a valve-closing direction. The valve constitutes a valve object which approaches or separates from the valve seat to close or open the air passage. The electromagnetic valve has a valve head and a shaft part. The valve head has a flange shape and is received in the housing to be able to open and close. The shaft part has a cylindrical shape straightly extending to an actuator from the central part of the valve head, and reciprocates in the axial direction.

The seal rubber mounted to the outer periphery part of the valve head has a ring part opposing to the valve seat and a seal lip projected toward the valve seat. In the cross-section, the seal lip has a taper shape inclined to the axis of the valve so that the tip end is located on the radially outer side of the root end. The seal rubber has plural load receptacle parts on the inner side of the seal lip. The projection length of the load receptacle part is smaller than that of the seal lip. The load receptacle part receives the load of the valve by contacting the valve seat when the valve is fully closed. At this time, the seal lip is elastically deformed to bend toward the outer periphery of the valve and is in the tight contact with the surface of the valve seat, when the valve is fully closed, such that a clearance between the valve head and the valve seat is certainly closed.

When the seal lip is not in contact with the valve, the seal lip extends obliquely upward from the surface of the valve head toward the valve seat. For this reason, water adhering to the surface of the valve head opposing to the valve seat may be supported by the seal lip to stay on the surface of the valve head. This phenomenon may be generated, for example, when exhaust gas flows backwards through the check valve that is opened such that water contained in the exhaust gas adheres to the surface of the valve head. The water staying on the surface of the valve head may cause freezing or locking of the valve to restrict normal operation of the valve.

### SUMMARY

It is an object of the present disclosure to provide a fluid control valve device in which freezing or locking is restricted.

According to an aspect of the present disclosure, a fluid control valve device includes a housing, a valve part, and a seal part. The housing has a valve seat, in which a fluid passage is defined, to have an annular shape. The valve part is able to open the fluid passage by moving away from the valve seat and to close the fluid passage by moving toward the valve seat. The seal part is disposed to the valve seat, and is elastically deformable. When the fluid passage is closed, the seal part is in contact with the valve part to intercept fluid from passing through the fluid passage. The seal part has a surface opposing the valve part, a first projection part projected from the surface toward an upper surface of the valve part and having an annular shape, and a second projection part defined to surround the first projection part and projected from the surface toward the upper surface of the valve part. The second projection part is adjacent to the upper surface of the valve part than the first projection part is.

Accordingly, when the valve part moves upward to the valve seat to perform a valve closing operation, the second projection part contacts the valve part and begins the elastic deformation. When the valve closing operation advances, the second projection part is bent by the valve part and has large elastic deformation. Therefore, a foreign substance such as water on the upper surface of the valve part can be removed by the second projection part. When the valve closing operation further advances, the first projection part contacts the valve part and has elastic deformation, while the flow of fluid passing through the fluid passage is intercepted such that the valve closing operation is completed. At this time, the second projection part has the maximum elastic deformation so that a foreign substance is removed from large area of the valve part. Thus, a foreign substance on the upper surface of the valve part can be dropped from the valve part in the process of the valve closing operation, such that the seal part can effectively remove the foreign substance. Therefore, freezing or locking of the valve part is restricted in the fluid control valve device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a view illustrating a secondary air feed system equipped with a secondary air regulator valve according to a first embodiment;

FIG. 2 is a sectional view illustrating the secondary air regulator valve of the first embodiment;

FIG. 3 is a partial view illustrating a first open state of the secondary air regulator valve of the first embodiment;

FIG. 4 is a partial view illustrating a second open state of the secondary air regulator valve of the first embodiment;

FIG. 5 is a partial view illustrating a first closed state of the secondary air regulator valve of the first embodiment;

FIG. 6 is a partial view illustrating a second closed state of the secondary air regulator valve of the first embodiment;

FIG. 7 is a partial view illustrating a first open state of a secondary air regulator valve according to a second embodiment;

FIG. 8 is a partial view illustrating a second open state of the secondary air regulator valve of the second embodiment;

FIG. 9 is a partial view illustrating a first closed state of the secondary air regulator valve of the second embodiment;

FIG. 10 is a partial view illustrating a second closed state of the secondary air regulator valve of the second embodiment;

FIG. 11 is a partial view illustrating a first open state of a secondary air regulator valve according to a third embodiment;

FIG. 12 is a partial view illustrating a second open state of the secondary air regulator valve of the third embodiment;

FIG. 13 is a partial view illustrating a first closed state of the secondary air regulator valve of the third embodiment;

FIG. 14 is a partial view illustrating a second closed state of the secondary air regulator valve of the third embodiment;

FIG. 15 is a partial view illustrating a first open state of a secondary air regulator valve according to a fourth embodiment;

FIG. 16 is a partial view illustrating a second open state of the secondary air regulator valve of the fourth embodiment;

FIG. 17 is a partial view illustrating a first closed state of the secondary air regulator valve of the fourth embodiment; and

FIG. 18 is a partial view illustrating a second closed state of the secondary air regulator valve of the fourth embodiment.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

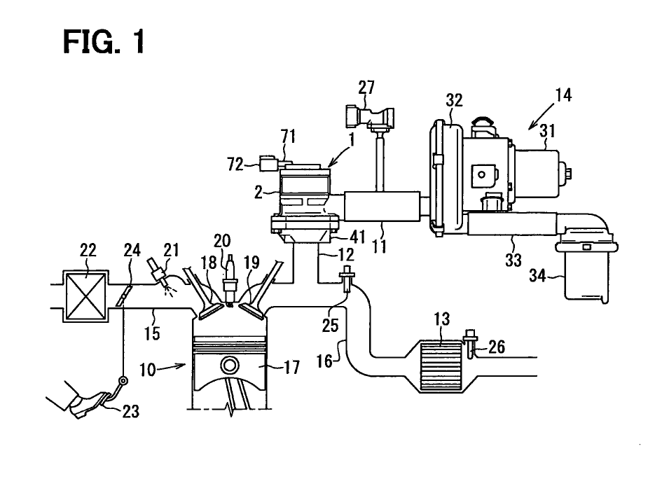

A fluid control valve device according to a first embodiment is explained referring to FIG. 1 to FIG. 6.

When an internal combustion engine such as gasoline engine is started, a secondary air feed system warms up a three-way catalyst. Specifically, secondary air in a secondary air pipe 11, 12 is introduced to a three-way catalyst converter 13 corresponding to an exhaust gas cleaning apparatus. The secondary air feed system is mounted to an engine compartment of a vehicle, and includes a secondary air regulator valve 1 as a fluid control valve device. An electric air pump 14 and the secondary air regulator valve 1 are gas-tightly connected to each other through the secondary air pipe 11. The secondary air regulator valve 1 and an exhaust pipe 16 are gas-tightly connected to each other through the secondary air pipe 12.

The three-way catalyst converter 13 cleans gas exhausted from the combustion chamber of each cylinder of the engine 10. Carbon monoxide, hydrocarbon, and nitrogen oxide contained in the exhausted gas are made harmless by the chemical reaction. The three-way catalyst converter 13 is an exhaust gas cleaning apparatus for the engine, for example, in which hydrocarbon is changed to harmless water by the oxidization action.

In the engine 10, thermal energy is produced by combustion of fuel-air mixture in the combustion chamber. The engine 10 has an intake pipe 15 supplying intake air to the combustion chamber of each cylinder, and the exhaust pipe 16 exhausting gas out of the combustion chamber of each cylinder to outside via the three-way catalyst converter 13. The engine 10 has a cylinder block which slidably supports the piston 17 within a cylinder bore, and a cylinder head with an intake port and an exhaust port.

The intake port and the exhaust port of the engine 10 are opened and closed by the intake valve 18 and the exhaust valve 19 respectively. The spark plug 20 is attached to the cylinder head of the engine 10 so that the tip end is exposed to the combustion chamber. An electromagnetic fuel injection valve 21 is attached on the wall surface of the intake, port or the back wall surface of the intake valve 18.

An intake passage is defined in the intake pipe 15, and is connected to the combustion chamber of the engine 10 through the intake port. Intake air is drawn to the combustion chamber of the engine 10 through the intake passage. An air cleaner 22 and a throttle valve 24 are received in the intake pipe 15. The air cleaner 22 filters intake air, and the throttle valve 24 opens and closes the passage corresponding to the operation of accelerator 23 (based on the accelerator valve opening).

An exhaust passage is defined in the exhaust pipe 16, and is connected to the combustion chamber of the engine 10 through the exhaust port. Exhaust gas flowing out of the combustion chamber of the engine 10 flows in the exhaust pipe 16 to the three-way catalyst converter 13. An air/fuel ratio sensor 25 detecting the air/fuel ratio (oxygen concentration) of exhaust gas, a catalyst temperature sensor 26 detecting the temperature of three-way catalyst, and an exhaust temperature sensor detecting the temperature of exhaust gas are arranged in the exhaust pipe 16.

The secondary air feed system includes the secondary air regulator valve 1, the secondary air pipe 11, 12 and the electric air pump 14. The secondary air passage defined in the secondary air pipe 11, 12 is connected to the exhaust passage of the exhaust pipe 16. Secondary air flows in the secondary air passage. A pressure sensor 27 which detects the pressure of secondary air is arranged in the secondary air pipe 11, 12.

The electric air pump 14 is gas-tightly connected to the upstream end of the secondary air pipe 11, and has an electric motor, a pump impeller and an air filter. The electric motor generates driving force by receiving supply of electric power. The pump impeller is rotated by the electric motor. The air filter prevents a foreign substance from entering the pump impeller. The electric air pump 14 has a motor housing 31, a pump housing 32, and a filter case 34. The motor housing 31 holds the electric motor inside. The pump housing 32 rotatably receives the pump impeller inside. The filter case 34 is gas-tightly combined with the pump housing 32 through an air duct 33.

The secondary air regulator valve 1 is gas-tightly connected between the secondary air pipe 11 and the secondary air pipe 12. The secondary air regulator valve 1 is an electromagnetic fluid control valve integrally having an air switching valve (ASV) and a check valve, and may be referred to a combination valve module. The air switching valve configures an electromagnetic valve that opens and closes the secondary air passage 35 defined inside of the housing 2. The check valve restricts fluid such as exhaust gas from flowing backwards to the system with ASV and the electric air pump from the connection at which the secondary air pipe 12 and the exhaust pipe 16 are connected.

The check valve includes a housing 41 combined to the downstream side of the housing 2 of ASV in the flowing direction of secondary air, and a metal plate 42 held at the housing 41. The check valve further includes a reed valve 44 and a reed stopper 45. The reed valve 44 has a thin film part which opens and closes plural air ports 43 defined in the metal plate 42. The reed stopper 45 regulates the opening degree or the maximum opening of the reed valve 44.

The housing 41 is gas-tightly connected to the upstream end of the secondary air pipe 12. When the reed valve 44 opens, the secondary air flows from the plural air ports 43 into a fluid outlet passage 46 defined in the housing 41, and flows out of the outlet port 47 that is an outlet part of the housing 41. The reed valve 44 is a valve object of the check valve that is opened by the pressure of secondary air output from the electric air pump 14.

ASV includes the housing 2, the poppet valve 4, the coil spring 7 and the seal part 9. The secondary air passage 35 is defined in the housing 2. The valve seat 3 having annular shape is integrally formed in the housing 2. The poppet valve 4 reciprocates in the axial direction to approach or separate from the valve seat 3. The coil spring 7 biases the valve head 5 and the shaft part 6 of the poppet valve 4 in the valve closing direction (to be seated on the valve seat 3). The seal part 9 is in contact with the valve head 5 when the valve is closed.

The secondary air feed system includes the engine control unit (ECU) which electronically controls the actuator which is a power source of the secondary air regulator valve 1 and the electric motor which is a power source of the electric air pump 14 based on the operational status of the engine 10. ECU has a microcomputer with CPU, memory such as ROM and RAM storing various programs and data an input circuit, an output circuit, an electromagnetic valve drive circuit, and a pump drive circuit.

When the ignition switch is turned on, ECU controls opening-and-closing operation of ASV of the secondary air regulator valve 1 by controlling the drive power supplied to the actuator of the secondary air regulator valve 1 based on the control program stored in the memory. Furthermore, ECU controls rotation operation such as speed of the electric air pump 14 by controlling the power supplied to the electric motor of the electric air pump 14.

The temperature of exhaust gas is detected by the exhaust temperature sensor at the time of starting the engine. When the temperature of exhaust gas is lower than or equal to a predetermined value, ECU controls to supply the drive power to the actuator of the secondary air regulator valve 1 to open the poppet valve 4. At this time, since electric power is supplied also to the electric motor of the electric air pump 14, flow of secondary air is generated inside the secondary air pipe 11, 12.

ECU has a failure-diagnosis function to diagnose failure of the electric air pump 14. When the pressure of secondary air detected by the pressure sensor 27 in the secondary air pipe 11, 12 is not in a predetermined pressure range, ECU determines that there is abnormality, and limits or stops the power supply to the actuator of the secondary air regulator valve 1 and the electric motor of the electric air pump 14.

The housing 2 of ASV is manufactured by die-casting with metal material such as aluminum, and has the cylindrical wall part 51. The poppet valve 4 is arranged in the cylindrical wall part 51. The inlet pipe 52 is integrally formed with the cylindrical wall part 51, and extends perpendicular to the cylindrical wall part 51. In other words, the radial direction of the cylindrical wall part 51 corresponds to the axial direction of the inlet pipe 52.

Secondary air flows into the air passage 55 defined inside the valve seat 3 via the fluid introduction passage 54 defined in the housing 2 from the inlet port 53 which is an inlet part of the inlet pipe 52. The communicate passage 56 is defined at the outlet part of the housing 2. The air passage 55 and the air ports 43 of the check valve communicate to each other through the communicate passage 56. An attachment part 57 is formed at the opening end, of the outlet part of the housing 2, and is combined with the housing 41. The secondary air passage 35 inside of ASV is configured by the air passage 55, the fluid introduction passage 54, and the communicate passage 56.

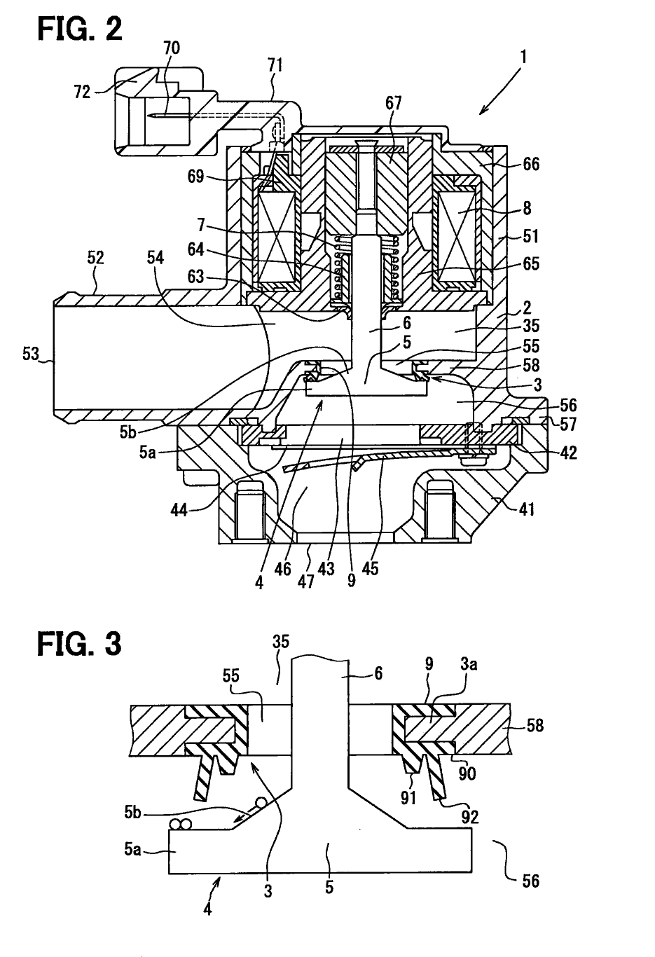

A circular partition part 58 is arranged to the inner circumference part of the cylindrical wall part 51, and divides the inside of the housing 2 into the fluid introduction passage 54 and the communicate passage 56. As shown in FIG. 2, at least the lower end surface of the partition part 58 integrally defines the valve seat 3 having a ring shape, to which the valve head 5 is seated. Secondary air passes through the round air passage which is formed in the valve seat 3 as a fluid passage.

The valve seat 3 is located around the peripheral part of the air passage 55, and is made of the same material as the housing 2. The valve seat 3 integrally has the seal part 9 to seal a clearance between the valve head 5 and the valve seat 3 by contacting with the valve head 5 when the poppet valve 4 is closed. The seal part 9 is formed entirely around the peripheral part of the air passage 55, and is made of elastomer such as fluorine base rubber or silicone rubber which is able to have elastic deformation.

The seal part 9 has a first projection part 91 and a second projection part 92. The first projection part 91 is projected from a surface 90 of the seal part 9 facing the valve head 5, and has a trapezoid shape in the cross-section. The first projection part 91 has an annular shape to surround the circumference of the air passage 55. The second projection part 92 is located on the radially outer side of the first projection part 91, and has an annular shape to surround the circumference of the first projection part 91. The projection length of the second projection part 92 from the surface 90 of the seal part 9 is larger than that of the first projection part 91.

The second projection part 92 has a rectangle shape in the cross-section, and has a root end defined on the surface 90 and a tip end. The root end is located on the radially inner side of the tip end. In other words, the root end is located adjacent to the air passage 55 than the tip end is.

The second projection part 92 that extends from the root end to the tip end is inclined to the surface 90, and extends outward in the radial direction. In the process of valve closing operation, when the valve head 5 presses the tip end of the second projection part 92 upward, the tip end is elastically deformed to be bent outward. When the valve head 5 further moves in the valve closing direction, the tip end continues deforming until the valve head 5 elastically deforms the first projection part 91.

The seal part 9 is integrally formed with the peripheral part 3a of the partition part 58 that defines the air passage 55. The seal part 9 is formed so that the surface 90 of the seal part 9 opposing the valve head 5 may not produce a substantial level difference relative to the surface of the partition part 58. The opposite surface of the seal part 9 opposite from the surface 90 also has no substantial level difference relative to the surface of the partition part 58. The seal part 9 may be arranged such that the surface 90 of the seal part 9 is on the same plane as the surface of the partition part 58. The seal part 9 is integrally attached to the partition part 58 to cover the peripheral part 3a by being fitted, baking, welding, or using adhesive.

The seal part 9 may be integrally formed with the peripheral part 3a as one-piece component with resin material by integral molding. The seal part 9 and the partition part 58 may be formed integrally with insert-molding using rubber and metal or two color formation (double-molding) using rubber and plastic material.

The lower end surface of the valve seat 3 having the annular shape may correspond to a regulation surface which regulates the operation range of the poppet valve 4 in the axial direction. The lower end surface of the valve seat 3 has the first projection part 91 corresponding to an inside annular part and the second projection part 92 corresponding to an outside annular part. The valve head 5 is seated onto the first projection part 91 tightly after contacting the second projection part 92, such that the upward operation of the poppet valve 4 is regulated (in the valve closing direction).

The valve seat 3 may be integrally combined into the housing 2 after manufactured as a component of the housing 2.

The poppet valve 4 is integrally molded using metal material such as stainless steel or resin material, and is movably held in the housing 2. The poppet valve 4 may correspond to a valve object which approaches the valve seat 3 to close the air passage 55 or which separates from the valve seat 3 to open the air passage 55. The poppet valve 4 integrally includes the shaft part 6 and the valve head 5. The shaft part 6 has a cylindrical shape extending from the central part of the valve head 5 upward to the actuator. The valve head 5 has a flange shape projected from the lower end of the shaft part 6, and has a size able to cover the air passage 55. The shaft part 6 passes through the air passage 55 in the axial direction. The upper (back) surface of the valve head 5 is seated onto the lower end surface of the valve seat 3. The valve head 5 has the shape of disk with an outer diameter that is larger than that of the shaft part 6.

The valve head 5 has a cone part 5b and an outer periphery part 5a. The cone part 5b defines a slope surface spreading downward from the lower end of the shaft part 6. The outer periphery part 5a is integrally defined on the lower end surface of the cone part 5b, and has an outer diameter that is larger than that of the cone part 5b. The outer diameter of the outer periphery part 5a is larger than that of the air passage 55. The upper surface of the outer periphery part 5a facing the seal part 9 defines a plane perpendicular to the axis of the shaft part 6.

The first projection part 91 and the second projection part 92 oppose to the upper surface of the outer periphery part 5a. When the shaft part 6 is seated on the valve seat 3, the first projection part 91 and the second projection part 92 are elastically deformed by contacting the shaft part 6.

The outer diameter of the outer periphery part 5a is larger than that of the second projection part 92 of the seal part 9 that is not compressed when the valve head 5 is not seated on the valve seat 3. In the cross-section, the valve head 5 has the shape combining the trapezoid portion to the rectangle portion. The trapezoid portion has a slope surface inclined to the axial direction (the up-and-down direction) to spread toward the outer periphery part 5a as extending downward. The rectangle portion is located on the lower end of the trapezoid portion. The valve head 5 and the shaft part 6 may be manufactured separately, and the poppet valve 4 may be produced by combining the valve head 5 and the shaft part 6.

When the valve head 5 is distanced from the valve seat 3 to fully open the valve, the valve head 5 is held in the middle of the communicate passage 56 that is a space defined between the check valve and the valve seat 3. That is, at the valve full open time, the poppet valve 4 is moved toward the check valve downward along the axis of the poppet valve 4. Furthermore, when the poppet valve 4 reciprocates along the axial direction of the shaft part 6, the valve head 5 is displaced in the axial direction relative to the valve seat 3.

When the poppet valve 4 moves in the valve opening direction downward along the axial direction, the valve head 5 is separated from the valve seat 3 to open the air passage 55 at the valve full open position.

When the poppet valve 4 moves in the valve closing direction upward along the axial direction, the valve head 5 is seated on the valve seat 3 and in contact with the first projection part 91 and the second projection part 92 to close the air passage 55 at the valve full closed position.

ASV is set at the valve full closed position when the poppet valve 4 is closed, and is set at the valve full open position when the poppet valve 4 is opened. ASV is able to change the position of the poppet valve 4 at least between two positions, i.e., the valve full open position and the valve full closed position. The poppet valve 4 is able to open the air passage 55, when the shaft part 6 is separated from the first projection part 91 and the second projection part 92. The poppet valve 4 is able to close the air passage 55, when the shaft part 6 contacts the first projection part 91 and the second projection part 92.

A circular seal rubber 63 is fitted around the outer periphery of the intermediate part of the shaft part 6 to prevent invasion of particulates to the slide portion of the shaft part 6. A plate pressure 64 is installed above the seal rubber 63 as a stopper which regulates the maximum lift amount of the poppet valve 4.

ASV is equipped with the actuator which is a valve drive device driving the poppet valve 4 in the valve opening direction. The actuator has the cylindrical wall part 51 of the housing 2, an electromagnet with a coil 8 which generates magnetic force by being supplied with electricity, and a moving core 67 attracted by the electromagnet. The electromagnet has the coil 8, a stator core 65, and a yoke 66. The stator core 65 and the yoke 66 are magnetized to be an electromagnet by supplying electric power to the coil 8. The stator core 65 has an attraction part for attracting the moving core 67.

The moving core 67 is press-fitted around the outer periphery of small diameter part located above the shaft part 6. When electric power is supplied to the coil 8, the moving core 67 is magnetized and moved with the poppet valve 4 downward in the axial direction (that is a stroke direction). The stator core 65, the yoke 66, and the moving core 67 are provided as plural magnetic bodies which form a magnetic circuit with the coil 8. Alternatively, only the stator core 65 and the moving core 67 may be formed as the plural magnetic bodies which form a magnetic circuit with the coil 8 by eliminating the yoke 66. The stator core 65 may be split into multiple pieces.

The coil spring 7 is held between the plate pressure 64 and the moving core 67. The coil spring 7 generates a spring load which is a biasing force to return the moving core 67 to a default position. Moreover, relative to the poppet valve 4 and the moving core 67, the coil spring 7 may correspond to a load generator that generates a biasing force biasing the valve head 5 to separate from the seal part 9.

The coil 8 has a bobbin 69 made of resin and wiring with insulation film wound around the bobbin 69. The coil 8 is a magnetization coil which generates magnetic attracting force (magnetomotive force) when electric power is supplied to provide magnetic flux. Since the moving core 67, the stator core 65, and the yoke 66 are magnetized by the magnetic flux, the moving core 67 is attracted by the attraction part of the stator core 65, and moves downward in the stroke direction. The coil 8 is held in the cylindrical space (coil storage part) between the inner circumference of the cylindrical wall part 51 or the yoke 66, and the outer periphery of the cylindrical part of the stator core 65.

The coil 8 has a coil part between flange parts of the bobbin 69 and a pair of terminal leads taken out from the coil part. The periphery side of the coil part is covered and protected with a resin mold component corresponding to a resin case. The terminal lead of the coil 8 is electrically connected to a terminal 70 by welding or plastically deforming. A tip part of the terminal 70 is exposed in a male connector 72 of a connector housing 71 made of resin, and is inserted in a female connector of an external power supply or an electromagnetic valve drive circuit to make electric connection as a connector pin.

When the valve head 5 approaches the valve seat 3 in a valve closing operation, water on the upper surface of the valve head 5 is made to drop as follows with reference to FIG. 3 to FIG. 6.

FIG. 3 illustrates a valve open state where the valve head 5 is distanced from the valve seat 3. In this state, the second projection part 92 is not in contact with the valve head 5. Therefore, the secondary air passage 35 and the communicate passage 56 communicate to each other. In this state, for example, in case where water (condensed moisture, water drop, deposit) contained in exhaust gas adheres to the upper surface of the valve head 5, the water flows along the slope surface of the cone part 5b. However, the water may stay on the upper surface of the outer periphery part 5a that extends in the horizontal direction. When the water freezes by being cooled, the frozen water may affect the operation of valve.

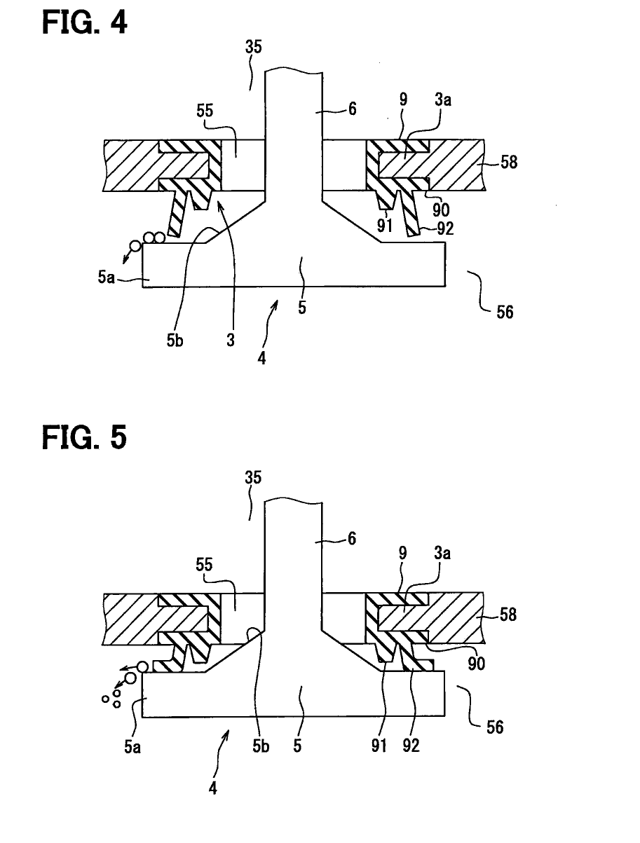

When the valve closing operation advances from the state shown in FIG. 3 to the state shown in FIG. 4, the second projection part 92 approaches close to the upper surface of the valve head 5. The water on the upper surface of the outer periphery part 5a begins to contact the second projection part 92, and is drained off from the valve head 5 by the tip part of the second projection part 92 located on the radially outer side than the root part. However, a part of the water may stay on the valve head 5.

When the valve closing operation advances from the state shown in FIG. 4 to the state shown in FIG. 5, the second projection part 92 comes to contact the upper surface of the outer periphery part 5a. Furthermore, when the valve is lifted upward to press the tip part of the second projection part 92 by the valve head 5, the tip part is elastically deformed to be bent outward in the radial direction. The second projection part 92 is bent at the middle, and the tip part comes to be located near the outer periphery edge of the valve head 5. Thus, most of the water on the upper surface of the outer periphery part 5a can be made to drop off from the valve head 5 by the second projection part 92.

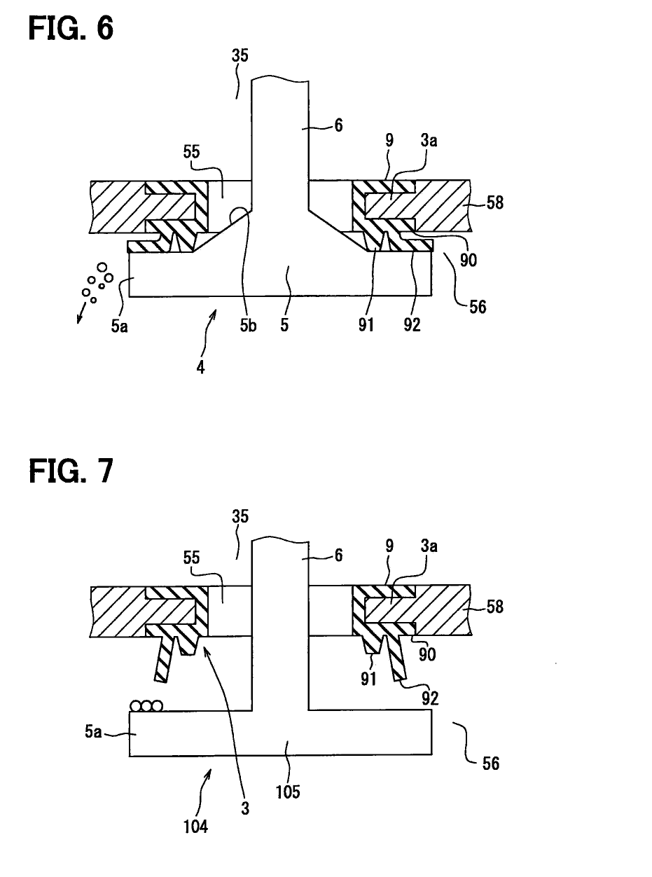

When the valve closing operation advances from the state shown in FIG. 5 to the state shown in FIG. 6, the first projection part 91 contacts the upper surface of the outer periphery part 5a, and a double seal structure is provided by the first projection part 91 and the second projection part 92. At this time, since the second projection part 92 is bent from the root part, the elastic deformation is made larger than that shown in FIG. 5 so that the tip part is located more outer side. Thus, the secondary air passage 35 and the communicate passage 56 are intercepted from each other when the valve is fully closed.

When the valve is fully closed, the elastic deformation of the second projection part 92 is the maximum so that the tip end is located at the position corresponding to the outer periphery edge surface of the valve head 5 or further outer side than the outer periphery edge surface. Thus, the remaining water on the upper surface of the valve head 5 positioned near the outer periphery edge surface in FIG. 5 can be made to drop off from the valve head 5 by the second projection part 92.

According to the first embodiment, when the valve is closed, a foreign substance such as water on the upper surface of the valve head 5 can be removed and dropped off from the upper surface of the valve head 5 by the elastic deformation of the second projection part 92 of the seal part 9 that defines the lip shape.

According to the first embodiment, a fluid control valve device has the valve head 5 and the seal part 9. The valve head 5 moves relative to the valve seat 3 upward or downward to close or open the air passage 55. The seal part 9 provided to the valve seat 3 contacts the valve head 5, when the valve is closed, to intercept fluid from passing through the air passage 55. The seal part 9 has the first projection part 91 projected from the surface 90 of the seal part 9 toward the upper surface of the valve head 5 to have the annular shape and the second projection part 92 projected to surround the first projection part 91. The second projection part 92 is located adjacent to the upper surface of the valve head 5 than the first projection part 91 is.

When the valve is closed by the valve head 5, the second projection part 92 contacts the valve head 5 and begins to have elastic deformation. When the valve closing operation advances, the second projection part 92 is bent and has more elastic deformation by the valve head 5, such that a foreign substance such as water on the upper surface of the valve head 5 is removed from the large area of the second projection part 92. When the valve closing operation further advances, the first projection part 91 is elastically deformed by contacting the valve head 5, and the flow of fluid passing the air passage 55 is intercepted to complete the valve closing operation. The second projection part 92 has the maximum elastic deformation so that a foreign substance can be further removed from the large area of the valve head 5. The seal part 9 can effectively remove the foreign substance staying on the upper surface of the valve head 5 by dropping from the valve head 5 in the process of valve closing operation.

Thus, in the fluid control valve device a foreign substance can be removed at each valve closing operation. Therefore, locking and freezing in a valve object can be controlled.

According to the first embodiment, the outer surface of the valve head 5 can be made flat by forming the seal part 9 at the valve seat 3. Therefore, it is difficult for the foreign substance such as water to stay on the valve head 5, such that locking and freezing in a valve object can be controlled.

The second projection part 92 has the tip end that is located adjacent to the radially outer periphery of the valve head 5 than the root end is. At each valve closing operation, the second projection part 92 has large elastic deformation in which the tip part is displaced to the outer side in the radial direction. Thus, a foreign substance can be removed by the elastic deformation of the second projection part 92 from the large area of the valve head 5.

The second projection part 92 may be projected annularly to surround all the circumference of the first projection part 91 in the circumference direction. The second projection part 92 can remove a foreign substance on the upper surface of the valve head 5 in each valve closing process, while the clearance between the valve head 5 and the valve seat 3 can be sealed by the second projection part 92. The fluid control valve device can offer both the removal effect of foreign substance and the double seal structure.

The cone part 5b of the valve head 5 has the slope surface inclined and spread downward at least in an area between the central axis of the valve head 5 and the second projection part 92. When a foreign substance such as water adheres at the position adjacent to the central axis of the valve head 5, it is possible to move the foreign substance out of the slope surface. Then, the foreign substance can be removed from the valve head 5 by the second projection part 92 at the time of valve closing operation. A foreign substance is removable from the wide range of the valve head 5 in the fluid control valve device.

The second projection part 92 has a thickness smaller than that of the first projection part 91. Therefore, when the valve closing operation is completed, the second projection part 92 can have elastic deformation larger than that of the first projection part 91 by the same load applied from the valve head 5. Therefore, a foreign substance can be effectively removed by the second projection part 92.

When the first projection part 91 is elastically deformed by contacting the valve head 5 to close the valve, the second projection part 92 is elastically deformed so that the tip end reaches at least the outer periphery end surface of the valve head 5. Accordingly, at the completion time of the valve closing operation, a foreign substance can be removed by the second projection part 92 from the wide area on the upper surface of the valve head 5 to the outer periphery end surface of the valve head 5.

### Second Embodiment

In a second embodiment, the poppet valve 4 of the first embodiment is modified as a poppet valve 104 with reference to FIG. 7 to FIG. 10.

The valve head 105 of the poppet valve 104 has the shape of a disk with an outer diameter that is larger than that of the shaft part 6, and is defined at the lower end of the shaft part 6 in the axial direction. The outer diameter of the valve head 105 is larger than that of the air passage 55, and the upper surface of the valve head 105 facing the seal part 9 defines a plane perpendicular to the axis of the shaft part 6. The poppet valve 104 has T-shape in the cross-section.

When the valve head 105 approaches the valve seat 3 in a valve closing operation, water on the upper surface of the valve head 105 is made to drop as follows with reference to FIG. 7 to FIG. 10.

FIG. 7 illustrates a valve open state where the valve head 105 is distanced from the valve seat 3. In this state, the second projection part 92 is not in contact with the valve head 105. Therefore, the secondary air passage 35 and the communicate passage 56 communicate to each other. In this state, for example, in case where water adheres to the upper surface of the valve head 105, the water stays on the upper surface of the valve head 5 that entirely extends in the horizontal direction.

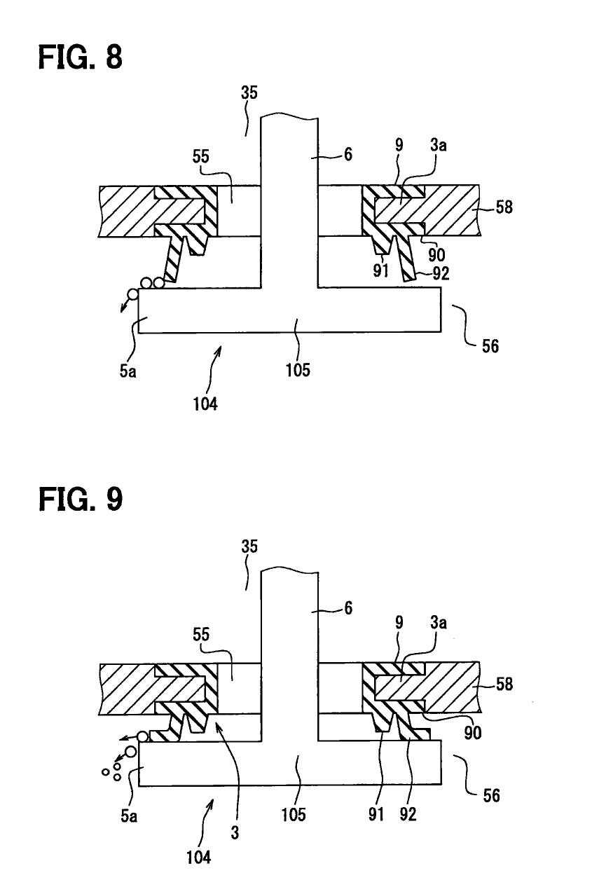

When the valve closing operation advances from the state shown in FIG. 7 to the state shown in FIG. 8, the second projection part 92 approaches the upper surface of the valve head 105. A part of the water on the upper surface of the valve head 105 begins to contact the second projection part 92, and is drained off from the valve head 105 by the tip part of the second projection part 92. However, a part of the water may stay on the valve head 105.

When the valve closing operation advances from the state shown in FIG. 8 to the state shown in FIG. 9, the second projection part 92 comes to contact the upper surface of the valve head 105. Furthermore, when the valve is lifted upward to press the tip part of the second projection part 92 by the valve head 105, the tip part is elastically deformed to be bent outward. The second projection part 92 is bent at the middle, and the tip part comes to be located near the outer periphery edge of the valve head 105. Thus, most of the water on the upper surface of the valve head 105 can be made to drop off from the valve head 105 by the second projection part 92.

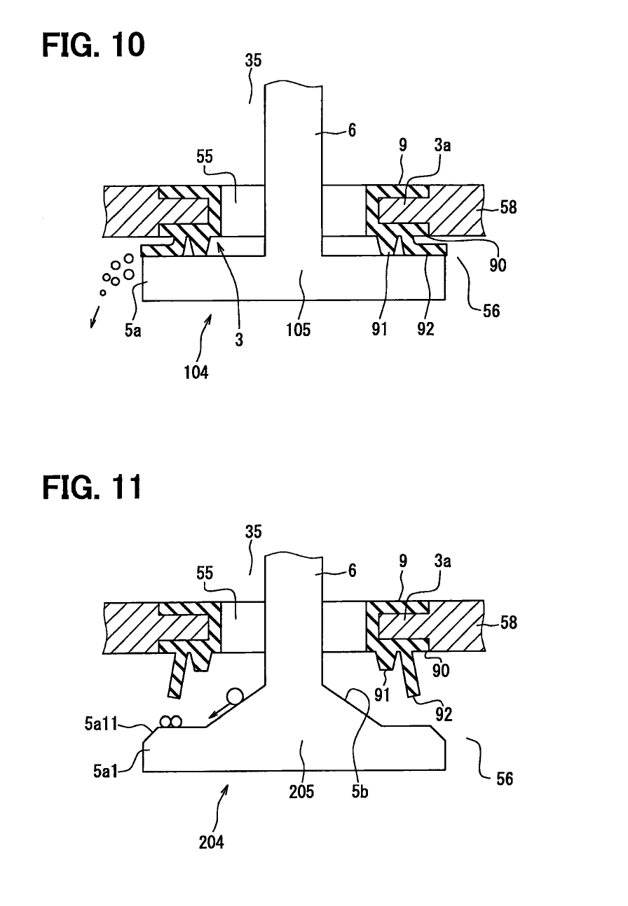

When the valve closing operation advances from the state shown in FIG. 9 to the state shown in FIG. 10, the first projection part 91 contacts the upper surface of the valve head 105, and a double seal structure is provided by the first projection part 91 and the second projection part 92. At this time, since the second projection part 92 is bent from the root part, the elastic deformation is made larger than the state shown in FIG. 9, so that the tip part is displaced more outer side in the radial direction. The secondary air passage 35 and the communicate passage 56 are intercepted from each other when the valve is fully closed.

When the valve is fully closed, the elastic deformation of the second projection part 92 is the maximum so that the tip end is located at the position corresponding to the outer periphery edge surface of the valve head 105 or further outer side than the outer periphery edge surface. Thus, the remaining water on the upper surface of the valve head 105 can be made to drop off from the valve head 105 by the second projection part 92.

According to the second embodiment, a foreign substance such as water on the upper surface of the valve head 105 can be removed by the elastic deformation of the second projection part 92 of the seal part 9 that defines the lip shape while the upper surface of the valve head 105 is flat.

According to the second embodiment, the first projection part 91 facilitates the sealing by contacting the flat upper surface of the valve head 105. Therefore, the sealing performance can be kept even if the center position of the shaft part 6 is deviated in the manufacturing or during the usage. Moreover, a valve center adjustment mechanism such as oscillation device can be made unnecessary.

### Third Embodiment

In a third embodiment, the poppet valve 4 of the first embodiment is modified as a poppet valve 204 with reference to FIG. 11 to FIG. 14.

The poppet valve 204 integrally includes the shaft part 6 and the valve head 205. The shaft part 6 has a cylindrical shape extending from the central part of the valve head 205 upward to the actuator. The valve head 205 has a flange shape projected from the lower end of the shaft part 6, and has a size able to cover the air passage 55. In addition to the cone part 5b, the valve head 205 has a periphery part 5a1 located on the lower side of the cone part 5b. An outer diameter of the periphery part 5a1 is larger than that of the cone part 5b. Compared with the valve head 5 of the first embodiment, the valve head 205 has the periphery part 5a1 where a slope surface 5a11 is formed on the upper surface of the edge portion of the periphery part 5a1.

The upper surface of the periphery part 5a1 has a flat surface and the slope surface 5a11. The flat surface of the periphery part 5a1 spreads outward in the radial direction from the slope surface of the cone part 5b. The slope surface 5a11 extends from the periphery part of the flat surface of the periphery part 5a1 to the outer end surface of the periphery part 5a1.

The slope surface 5a11 has a cone shape spreading downward, similarly to the cone part 5b. That is, the periphery part 5a1 has the outer shape in which the angle part of the upper surface is cut off to round the corner. In the state where the valve head 5 is not seated on the valve seat 3, the second projection part 92 of the seal part 9 is set at the position where the second projection part 92 opposes the flat surface of the periphery part 5a1.

When the valve head 205 approaches the valve seat 3 in a valve closing operation, water on the upper surface of the valve head 205 is made to drop as follows with reference to FIG. 11 to FIG. 14.

FIG. 11 illustrates a valve open state where the valve head 205 is distanced from the valve seat 3. In this state, the second projection part 92 is not in contact with the valve head 205. Therefore, the secondary air passage 35 and the communicate passage 56 communicate to each other. In this state, for example, when water or deposit adheres to the upper surface of the valve head 205, water flows along the slope surface of the cone part 5b. However, water stays on the flat surface of the periphery part 5a1 that extends in the horizontal direction. When water freezes by being cooled, the frozen water may affect the operation of valve.

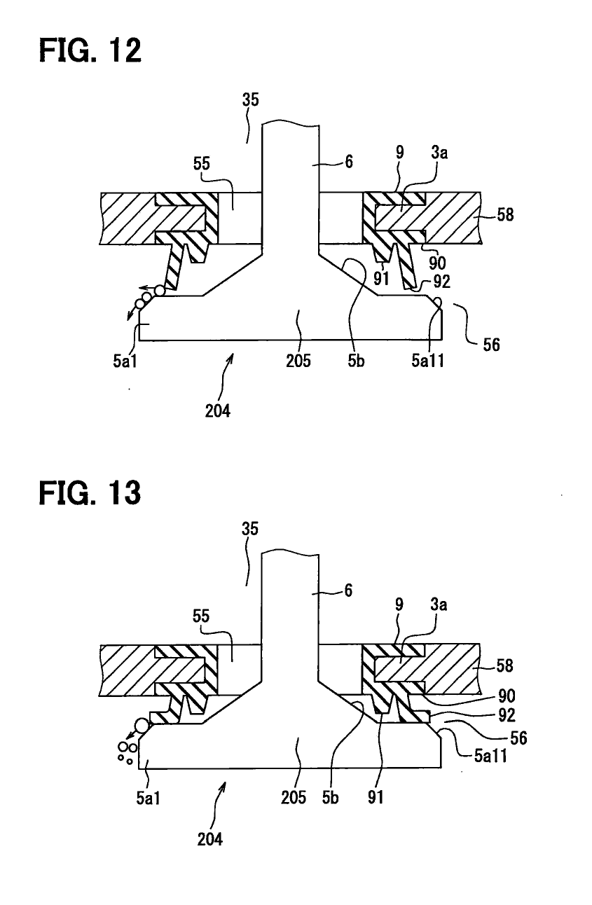

When the valve closing operation advances from the state shown in FIG. 11 to the state shown in FIG. 12, the second projection part 92 approaches the upper surface of the valve head 205. The water on the flat surface of the periphery part 5a1 begins to contact the second projection part 92, and is drained off from the valve head 205 by the tip part of the second projection part 92. At this time, when the water arrives at the slope surface 5a11, the water flows along the slope surface 5a11 to fall.

When the valve closing operation advances from the state shown in FIG. 12 to the state shown in FIG. 13, the second projection part 92 comes to contact the upper surface of the periphery part 5a1. Furthermore, when the valve is lifted upward to press the tip part of the second projection part 92 by the flat surface of the valve head 205, the tip part of the second projection part 92 is elastically deformed to be bent outward. The second projection part 92 is bent at the middle, and the tip part comes to be located near the outer periphery edge of the flat surface of the valve head 205. Thus, the water on the upper surface of the valve head 205 in FIG. 12 can reach the slope surface 5a11 and drop off from the valve head 205 via the slope surface 5a11.

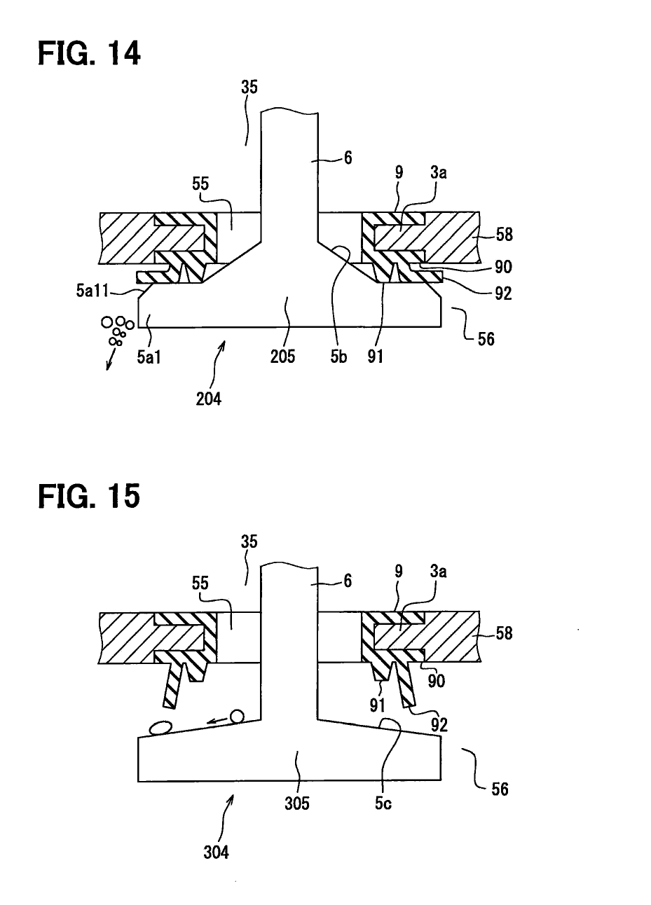

When the valve closing operation advances from the state shown in FIG. 13 to the state shown in FIG. 14, the first projection part 91 contacts the upper surface of the periphery part 5a1, and a double seal structure is provided by the first projection part 91 and the second projection part 92. At this time, since the second projection part 92 is bent from the root part, the elastic deformation is made larger than the state shown in FIG. 13 so that the tip part of the second projection part 92 is displaced to more outer side in the radial direction. The secondary air passage 35 and the communicate passage 56 are intercepted from each other when the valve is fully closed.

When the valve is fully closed, the elastic deformation of the second projection part 92 is the maximum so that the tip end of the second projection part 92 arrives at the slope surface 5a11.

According to the third embodiment, a foreign substance such as water on the upper surface of the valve head 205 can be removed by the elastic deformation of the second projection part 92 of the seal part 9 that defines the lip shape.

According to the third embodiment, the valve head 205 has the slope surface 5a11 spreading downward in a cone shape at the upper surface of the periphery part 5a1. A foreign substance near the periphery edge of the valve head 205 can be dropped due to the slope surface 5a11. The foreign substance which cannot be dropped by the second projection part 92 can be removed from the valve head 205 by moving the foreign substance to the periphery edge of the valve head 205. Therefore, the performance of removing a foreign substance can be raised.

### Fourth Embodiment

In a fourth embodiment, the poppet valve 4 of the first embodiment is modified as a poppet valve 304 with reference to FIG. 15 to FIG. 18.

The poppet valve 304 integrally includes the shaft part 6 and the valve head 305. The shaft part 6 has a cylindrical shape extending from the central part of the valve head 305 upward to the actuator. The valve head 305 has a flange shape projected from the lower end of the shaft part 6, and has a size able to cover the air passage 55. The valve head 305 has the upper surface constructed of a slope surface 5c. The slope surface 5c may have a cone shape spreading downward from the lower end of the shaft part 6. The slope surface 5c is continuously formed from the lower end of the shaft part 6 to the outer periphery edge of the valve head 305. Therefore, the highest part of the slope surface 5c is located at a position higher than the outer periphery edge of the valve head 305. Compared with the valve head 5 of the first embodiment, the valve head 305 has no flat surface spreading in the horizontal direction.

When the valve head 305 approaches the valve seat 3 in a valve closing operation, water on the upper surface of the valve head 305 is made to drop as follows with reference to FIG. 15 to FIG. 18.

FIG. 15 illustrates a valve open state where the valve head 305 is distanced from the valve seat 3. In this state, the second projection part 92 is not in contact with the valve head 305. Therefore, the secondary air passage 35 and the communicate passage 56 communicate to each other. In this state, for example, when water or deposit adheres to the upper surface of the valve head 305, water flows along the slope surface 5c. However, a part of the water may stay on the slope surface 5c. At this time, the poppet valve 304 of the fourth embodiment can remove the water staying near the outer periphery edge of the valve head 305 as follows.

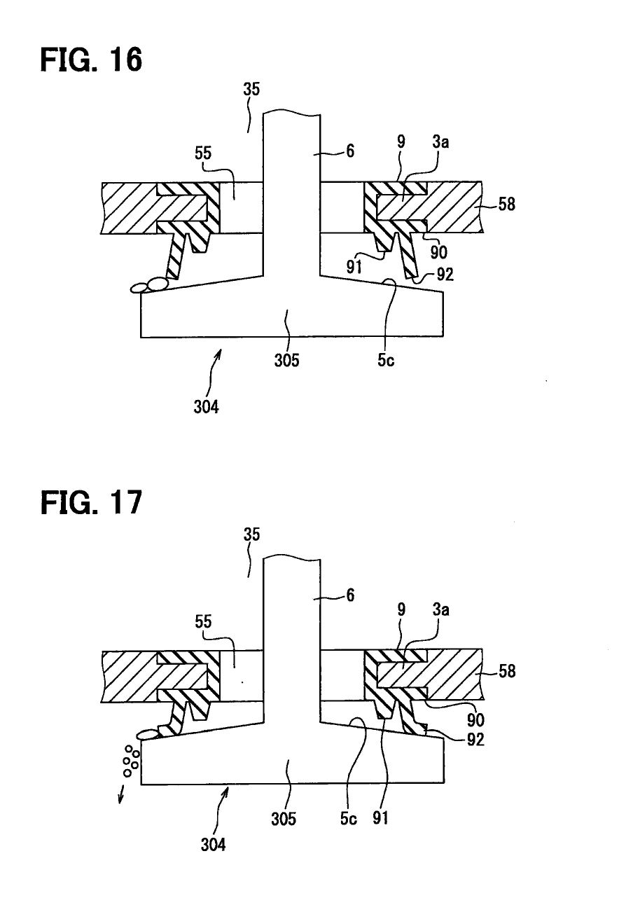

When the valve closing operation advances from the state shown in FIG. 15 to the state shown in FIG. 16, the second projection part 92 approaches close to the upper surface of the valve head 305. The water on the slope surface 5c begins to contact the second projection part 92, and is drained off from the valve head 305 by the tip part of the second projection part 92 located on the radially outer side than the root part.

When the valve closing operation advances from the state shown in FIG. 16 to the state shown in FIG. 17, the second projection part 92 comes to contact the upper surface of the slope surface 5c. Furthermore, when the valve is lifted upward to press the tip part of the second projection part 92 by the slope surface 5c, the tip part is elastically deformed to be bent outward. The second projection part 92 is bent at the middle, such that the water on the slope surface 5c can be made to drop off.

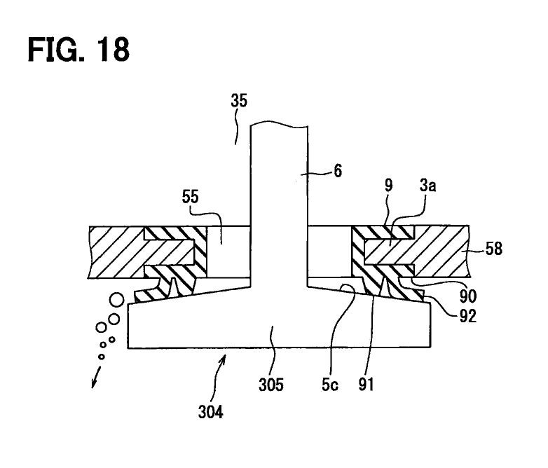

When the valve closing operation advances from the state shown in FIG. 17 to the state shown in FIG. 18, the first projection part 91 contacts the slope surface 5c, and a double seal structure is provided by the first projection part 91 and the second projection part 92. At this time, since the second projection part 92 is bent from the root part, the elastic deformation is made larger than the state shown in FIG. 17 so that the tip part is displaced to more outer side in the radial direction. Thereby, the secondary air passage 35 and the communicate passage 56 are intercepted from each other when the valve is fully closed.

When the valve is fully closed, the second projection part 92 has the maximum elastic deformation so that the tip end is displaced to the outer side as much as possible in the radial direction.

According to the fourth embodiment, a foreign substance such as water on the upper surface of the valve head 305 can be removed by the elastic deformation of the second projection part 92 of the seal part 9 that defines the lip shape in the valve closing operation.

According to the fourth embodiment, the valve head 305 has the slope surface 5c spreading downward with the cone shape, and the slope surface 5c is defined entirely on the whole upper surface. A foreign substance such as water adhering to the upper surface of the valve head 305 can flow down along the slope surface 5c formed on the whole upper surface. Then, the foreign substance can be dropped by the second projection part 92 from the valve head 305 in the valve closing operation. Thus, a foreign substance is removable from the wide range of the valve head 305 in the fluid control valve device.

### Other Embodiment

The second projection part 92 is not limited to have the annular shape that surrounds all the circumference of the first projection part 91. The second projection part 92 may partially surround the first projection part 91. In this case, a foreign substance such as water adhering to the upper surface of a valve head can be removed at a valve closing time.

For example, the second projection part 92 may be split into plural pieces surrounding all the circumference of the first projection part 91 at a predetermined interval or predetermined angle pitch. The second projection part 92 may be one of a plurality of second projection parts 92 annularly formed over all the circumference of the first projection part 91. The annular shape may be partially cutout as a slit at some places.

The root part of the second projection part 92 may have a thickness thicker than that of the tip part of the second projection part 92. The thickness of the second projection part 92 may be gradually or stepwise made thinner as extending to the tip end from the root end. In this case, the tip part of the second projection part 92 is easy to have elastic deformation when pressed upward by a valve head in process of valve closing operation. The elastic deformation of the second projection part 92 can be large so that foreign substance such as water can be removed.

Such changes and modifications are to be understood as being within the scope of the present disclosure as defined by the appended claims.

What is claimed is:

1. A fluid control valve device comprising:
a housing having a valve seat, in which a fluid passage is defined, to have an annular shape;
a valve part that is able to open the fluid passage by moving away from the valve seat and to close the fluid passage by moving toward the valve seat; and
a seal part disposed to the valve seat, the seal part being elastically deformable and contacting the valve part when the fluid passage is closed to intercept fluid from passing through the fluid passage, wherein
the seal part has
a surface opposing the valve part,
a first projection part projected from the surface toward an upper surface of the valve part and having an annular shape, and
a second projection part defined to surround the first projection part and projected from the surface toward the upper surface of the valve part, and
the second projection part is adjacent to the upper surface of the valve part than the first projection part is.

2. The fluid control valve device according to claim 1, wherein
the second projection part has
a root end defined on the surface of the seal part, and
a tip end located adjacent to the upper surface of the valve part, and
the tip end is located adjacent to an outer periphery of the valve part than the root end is.

3. The fluid control valve device according to claim 1, wherein
the second projection part has an annular shape entirely surrounding the first projection part in a circumference direction.

4. The fluid control valve device according to claim 1, wherein
the valve part has a slope surface at least in an area between a central axis of the valve part and the second projection part to define a cone shape.

5. The fluid control valve device according to claim 2, wherein
the second projection part has a thickness smaller than that of the first projection part.

6. The fluid control valve device according to claim 1, wherein
the second projection part is elastically deformed so that a tip end of the second projection part reaches at least an outer periphery surface of the valve part when the first projection part is in contact with the valve part to close the fluid passage.

7. The fluid control valve device according to claim 1, wherein
the surface of the seal part is on a same plane as a surface of the housing that defines the valve seat so as not to produce a level difference between the surface of the seal part and the surface of the housing.

8. The fluid control valve device according to claim 1, wherein the valve part has a slope surface on the upper surface at a position on a radially outer side of the second projection part to define a cone shape.

9. The fluid control valve device according to claim 1, wherein the valve part has a slope surface entirely on the upper surface of the valve part to define a cone shape.
